(19) United States
(12) Patent Application Publication
(10) Pub. No.: US 2026/0368903 A1
(43) Pub. Date: Nov. 19, 2026

(54) A METHOD FOR INSTANCE SEGMENTATION USING INNER MASK(S)

(71) Applicant: RATION EHF., Reykjavik (IS)

(72) Inventor: Hans Emil ATLASON, Kópavogur (IS)

(21) Appl. No.: 19/486,191

(22) PCT Filed: May 22, 2024
(86) PCT No.: PCT/IS2024/050002

§ 371 Date: Nov. 20, 2025

(30) Foreign Application Priority Data
May 22, 2023 (IS) 050398

(51) Int. Cl. G06T 7/12; G06N 3/0464; G06N 3/08; G06T 5/70; G06V 10/75; G06V 20/68; G06V 20/70

(52) U.S. Cl. CPC G06T 7/12; G06N 3/0464; G06N 3/08; G06T 5/70; G06V 10/758; G06V 20/68; G06V 20/70; G06T 2207/30242

(57) ABSTRACT

A computer implemented method and a system for performing efficient image segmentation of a digital image by identifying at least one inner mask for at least one object in the digital image and using the inner mask(s) to construct an instance segmentation for the given digital image allowing at least object to be counted, to measure the size and/or shape of the at least one object and to detect anomalies in said at least one object.

### FIELD OF INVENTION

The invention is within the field of image analysis, in particular image segmentation. The disclosure relates to method and system for (autonomous) identification, and analysis of items or objects of interest in an image.

### TECHNICAL BACKGROUND

Image recognition has recently gained an important role in computer vision applications such as autonomous driving, robotics and surveillance systems. The main objective of image recognition is to be able to detect, identify and/or classify visual elements in a digital image. A digital image is a collection of pixels, wherein the numeric value of each pixel represents the intensity of the image at the position of the pixel. The spatial location of each pixel is given by its coordinates within the image relative to a point of origin. In computer vision applications, the visual elements of a digital image are typically divided into two groups. The first group involves measurable objects called “objects of interest” or “objects” for short, while the second group refers to the remaining elements in the digital image, collectively referred to as “background”. Numerous methods and algorithms have been proposed to segment and identify these objects in images.

The conventional image segmentation techniques can be divided into three groups, i.e., semantic segmentation [1], instance segmentation [2] and panoptic segmentation [3]. Semantic segmentation involves segmentation, identification, and classification according to a pre-defined set of categories, wherein the classification is carried out on the pixel level, wherein each individual pixel comprised in a digital image is classified and given a value corresponding to the pre-defined category. Instance segmentation relates to segmentation and identification of single objects, also referred to as instances. The terms “object” or “object of interest” and instances may be used herein interchangeably, and the meaning may be derived from context, by the skilled person. In this regard, instance segmentation utilizes an array of pixel masks for object detection. Herein, the term “masks” refers to a single pixel or a collection of pixels selected based on some attribute, e.g., spatial location and value. Panoptic segmentation combines both semantic and instance segmentation by differentiating between distinct objects and identifying unique samples of each object type. For this technique, each pixel of an image must be provided with a class label. For countable objects, the label is used to discriminate across different objects. However, with non-countable objects, it is neither essential nor sometimes even viable to differentiate between samples. Thus, pixels within each of the categories are given the same label.

Image segmentation methods carried out with or augmented by machine learning, in particular deep learning, are becoming more and more popular in recent years with the advent of computationally efficient developments in machine learning and rapid growth of widely available computational resources. Convolutional neural networks (CNNs) are the most common deep learning method used in image analysis, although transformers [4] are also increasingly being used. The problem with CNNs is that they do not have a way to directly provide an unknown number of outputs which is required for instance segmentation (identification of individual objects), although this has partially been circumvented by using the region proposal method [5,6], distance from boundaries/centroids [7], shape [8], vector fields [9], combined with secondary processing [10].

Convolutional neural networks may be used for analysis of both two-dimensional or three-dimensional images and even though the majority of such analysis (and development) is carried out for two-dimensional images, many problems still remain to be solved. One such unsolved problem is how to treat two or more objects that comprise coinciding boundaries, this results in two or more objects having partially overlapping bodies. The overlap may easily vary depending on the nature of the objects in question and application, but generally, with increasing degree of overlap between two or more objects, the more difficult image segmentation becomes with CNNs and region-based algorithms that act independently on each object [10]. Further challenges of instance segmentation include under or over segmentation of the techniques [11], wherein two or more objects may be segmented to form a single instance or wherein a single object is segmented into two or more instances, respectively. In some cases, instance segmentation of irregular shapes (or a collection of irregular shapes) may prove problematic. Moreover, many of recent state-of-the-art techniques and algorithms used for instance segmentation do not provide solutions that are fast enough to be used for image analysis in real-time and the advent of even more computationally efficient methods is required for such applications.

Commonly used state-of-the-art methods for instance segmentation are mask R-CNN [5] which is based on the region proposal and box prediction method Faster R-CNN [6]. While it yields somewhat accurate results, it is proven to be inaccurate for object boundaries and treating overlap of two or more objects. YOLACT [12] is a similar method to Faster R-CNN but with improved computational efficiency. The conventional instance segmentation methods comprise creating patches from images and run each patch through the machine learning model (e.g., a network) to acquire bounding boxes, which may require running a plurality of inferences on the image and/or require domain specific fine-tuning. Affinity kernel-based methods [13,14,15] have the potential to connect pixels of the same instance in situations with overlapping objects and objects with irregular shape. For these methods, however, it remains a challenge to construct a kernel that simultaneously connects disconnected parts of an instance, while maintaining sufficient resolution of the kernel.

There have been various systems and methods devised to train machine learning models for instance segmentation. US2020327667 discloses how to train a machine learning model/deep learning model for instance segmentation when using partially annotated training data. For this purpose, a first image showing the field of view for a biological sample and an annotated second image comprising first image partially annotated are run through an encoder (i.e., a machine learning network) to generate a third and fourth image. A machine learning model (or system) may then be trained on the generated third and fourth images. The trained machine learning model can be used to predict labelling of objects comprised in an (unknown) input image.

US2021374453A1 discloses a method for segmenting an image into objects. The method comprises identifying regions in one or more objects comprised in an input image e.g., by predicting a bounding box (i.e., an edge that is predicted to enclose an object in an image). For each pixel, in the identified regions in the one or more objects, a likelihood score whether the pixel belongs to the object. This may be carried out using a training set of example object segmentations and by assessing the similarities between the objects of the image and the example objects of the training set, wherein the similarities are assessed by generating and assigning values to weights. Finally, a segmentation is produced for the object based on the likelihood scores.

Embodiments of the present invention seek to overcome above mentioned disadvantages and/or to provide an improved computer-implemented instance segmentation method.

### REFERENCES

[1] Ronneberger, O., Fischer, P. and Brox, T., 2015. U-net: Convolutional networks for biomedical image segmentation. In Medical Image Computing and Computer-Assisted Intervention—MICCAI 2015:18th International Conference, Munich, Germany, Oct. 5-9, 2015, Proceedings, Part III 18 (pp. 234-241). Springer International Publishing.

[2] Gu, W., Bai, S. and Kong, L., 2022. A review on 2D instance segmentation based on deep neural networks. Image and Vision Computing, p.104401.

[3] A Kirillov, K. He, R. Girshick, C. Rother, and P. Dollár, 2019. Panoptic Segmentation, In Proc. of the IEEE/CVF Conference on Computer vision and Pattern recognition, pp. 9904-9413.

[4] Liu, Z., Lin, Y., Cao, Y., Hu, H., Wei, Y., Zhang, Z., Lin, S. and Guo, B., 2021.Swin transformer: Hierarchical vision transformer using shifted windows. In Proceedings of the IEEE/CVF international conference on computer vision (pp. 10012-10022).

[5] He, K., Gkioxari, G., Dollár, P. and Girshick, R., 2017. Mask r-cnn. In Proceedings of the IEEE international conference on computer vision (pp. 2961-2969).

[6] Ren, S., He, K., Girshick, R. and Sun, J., 2015. Faster r-cnn: Towards real-time object detection with region proposal networks. Advances in neural information processing systems, 28.

[7] Watanabe, T. and Wolf, D., 2018, November. Distance to center of mass encoding for instance segmentation. In 2018 21st International conference on intelligent transportation systems (ITSC) (pp. 3825-3831). IEEE.

[8] Xu, W., Wang, H., Qi, F. and Lu, C., 2019. Explicit shape encoding for real-time instance segmentation. In Proceedings of the IEEE/CVF International Conference on Computer Vision (pp. 5168-5177).

[9] Stringer, C., Wang, T., Michaelos, M. and Pachitariu, M., 2021. Cellpose: a generalist algorithm for cellular segmentation. Nature methods, 18 (1), pp. 100-106.

[10] Bai, M. and Urtasun, R., 2017. Deep watershed transform for instance segmentation. In Proceedings of the IEEE conference on computer vision and pattern recognition (pp. 5221-5229).

[11] Tang, C., Chen, H., Li, X., Li, J., Zhang, Z. and Hu, X., 2021. Look closer to segment better: Boundary patch refinement for instance segmentation. In Proceedings of the IEEE/CVF Conference on Computer Vision and Pattern Recognition (pp. 13926-13935).

[12] Bolya, D., Zhou, C., Xiao, F. and Lee, Y.J., 2019. Yolact: Real-time instance segmentation. In Proceedings of the IEEE/CVF international conference on computer vision (pp. 9157-9166).

[13] Yang, L., Wei, Y.Z., He, Y., Sun, W., Huang, Z., Huang, H. and Fan, H., 2021.ishape: A first step towards irregular shape instance segmentation. arXiv preprint arXiv:2109.15068.

[14] Gao, N., Shan, Y., Wang, Y., Zhao, X., Yu, Y., Yang, M. and Huang, K., 2019.Ssap: Single-shot instance segmentation with affinity pyramid. In Proceedings of the IEEE/CVF international conference on computer vision (pp. 642-651).

[15] Liu, Y., Yang, S., Li, B., Zhou, W., Xu, J., Li, H. and Lu, Y., 2018. Affinity derivation and graph merge for instance segmentation. In Proceedings of the European Conference on Computer Vision (ECCV) (pp. 686-703).

### SUMMARY

The present invention is specified in the claims as well as in the below description.

The present invention relates to an efficient and robust computer-implemented method and a system used to analyse digital images e.g., with respect to the number of individual objects contained within said image, be used to measure or analyse the shape and/or size of said objects, as well as identify deformed or damaged objects.

The method may advantageously be used to treat images wherein the area defined by a single object or instance in a digital image may coincide and cover parts of an area of another individual object or an instance, regardless of whether the objects are of the same type, i.e., to resolve overlapping of two or more instances, rendering the method and system particularly useful for counting objects and measuring the shape and/or size of each object. The method achieves this by decomposing an image (which may comprise one or more objects of interest and background) into localized regions of pixels, referred to as inner masks (see more precise definition below), and then by assembling an instance segmentation from said inner masks, e.g., by associating inner masks to objects. In conventional segmentation methods, a single segmentation image is typically used to represent all instances within an image, which fails to handle scenarios where one pixel is shared by multiple instances. This limitation prevents accurate representation of overlapping objects. The present invention overcomes this limitation by generating a parameterization of instances or separate segmentation images for each instance. This approach allows for significant overlap between instances, enabling more precise segmentation. For example, if two elongated objects are laid orthogonally on top of each other, conventional methods might incorrectly segment them as distinct instances or fail to recognize the overlap accurately. In contrast, the methods of the present invention will correctly identify and segment each elongated object, even when they overlap, maintaining the integrity of each instance.

Herein, the term “inner mask” of an object refers to at least one pixel, or preferably, a collection of pixels that belong to, or are contained within, an object associated with said inner mask such that the inner mask pixels are positioned in a region of the image that falls within the encapsulating boundary of the object or instance. In other words, an inner mask may be a localized region of pixels within an object or an instance in an image with the boundary pixels of the object or instance excluded. Each pixel of an inner mask may have a position assigned to it in reference to the frame of an image, e.g., the width and height of the image. Accordingly, an inner mask may be represented by a binary image of the same height and width as the image of interest, wherein a pixel with a non-zero value (or “true” value) corresponds to a pixel within the instance/object that the mask corresponds to, while the remainder of the pixels in the binary image are assigned a zero value.

In images wherein two or more objects may have coinciding boundaries (i.e., two objects exhibit overlap in the image) a single object may yield two or more inner masks.

Another advantage of the method is that it is only required to run inference on an image once. The post-processing method, as described below, is very computationally efficient and does not require domain specific fine-tuning. However, it is possible for a user to predefine a shape category, or list of shape categories, for an even greater computational speed-up.

The method and system are, therefore, highly useful in most industries and production lines where items need to be automatically counted and/or analysed such as, but not limited to, the food industry and metallurgy industry.

An aspect of the invention provides a computer-implemented method for instance segmentation of an image comprising at least one object and background for identifying at least one object in said image, wherein said computer-implemented method comprises steps of; predicting at least one inner mask for at least one object in said image and determining an instance segmentation from said at least one inner mask.

In one embodiment, the image is a digital image. The image may be received from, or provided by, at least one camera. The image may be processed into a digital image by at least one camera. Alternatively, a captured image may be received and processed into a digital image by a control unit. A digital image, or a digital representation thereof, may be stored in a (non-transitory) computer-readable memory.

In one embodiment, the step of predicting at least one inner mask for at least one object may further comprise steps of; training a machine learning model on a set, or a database, of training images, wherein said set of training images comprises a set of digital images and corresponding boundary distance images (i.e., images with target property being the boundary distance), generating a set of boundary distance images for said image using said trained machine learning module and said image as input. In some embodiments, this step may require the definition of a set of directions to generate said boundary distances images for said set directions. Then, computing a measure of statistical spread across said set of boundary distance images for each pixel in said boundary distance images, defining (i.e., determining) the at least one inner mask for at least one object by thresholding said measure of statistical spread. The thresholding may be carried out according to a predefined threshold value, e.g., by pre-optimization or alternatively, the threshold value may be found by iteratively refining the value by iteratively thresholding the image and counting number of inner masks/instances. Then, connected component labelling may be used to label each separate instance of inner mask.

The training of the machine learning model on a set of training images may be carried out prior to or during the execution of the method of the present invention. In some embodiments, there may be time-lag between the step of training the machine learning model and using said machine learning model. The training set comprises a set of digital images as the input images and the corresponding boundary distance images as the output/target property. In one embodiment, the training phase of the machine learning model may be centred on learning a function e.g., by adjusting statistical weights or expansion coefficients, such as to minimize a given loss function between at least one inputted image and at least one corresponding target property. After training, the trained machine learning model may be used to predict a boundary distance image for any given input image, for example an input image not included in the training set, or database of training images. The training set may comprise any number of training images and the corresponding boundary distance images (also along different directions). Moreover, to improve the accuracy of the prediction more training data may be added to the training set and the trained machine learning model updated.

The measure of statistical spread may be selected to be of any suitable choice as recognized by the person skilled in the art. In one embodiment, the measure of statistical spread may be selected as variance. In another embodiment, the measure of statistical spread may be selected as standard deviation.

In one embodiment, the measure of statistical spread across the set of boundary distance images may be filtered prior to being used to identify at least inner mask. Moreover, the measure of statistical spread may be subjected to blurring such as, but not limited to, gaussian blurring. Alternatively, the image may be filtered or blurred prior to the computation of statistical spread.

After computation of the measure of statistical spread across the set of boundary distance images and/or filtering and/or blurring of said measure of statistical spread, the value of each pixel may be compared to a threshold value to identify at least one region of pixels located within the boundaries of least one object, i.e., said at least one region of pixels is enclosed within the boundary pixels of said object (at least one inner mask). Depending on the case, a single object may, in some instances, yield one or more inner mask(s).

The threshold value may be pre-determined or obtained on-the-fly during execution of the method of the present invention.

In one embodiment, at least one pixel with a local minimum and/or local maximum in the measure of statistical spread across the set of boundary distance images may be identified and is then referred to as a centroid pixel or a centroid for short. In another embodiment, the step of thresholding may be omitted, and the identification of inner mask equals the step of identifying centroids, wherein the inner mask is defined solely by the centroid pixel(s).

In one embodiment, determining an instance segmentation corresponding to said at least one inner mask further comprises steps of: determining the basic shape associated with the at least one inner mask using (or by referring to) the boundary distance image, determining the least one parameter of the basic shape from the boundary distance image at a location of at least one pixel within the at least one inner mask using data from the boundary distance image.

The basic shape associated with each inner mask may be determined by the boundary distance image or alternatively inputted by the user to increase the efficiency of the method. In other words, the basic shape associated with the at least one inner mask can be determined from the object shapes by referring the boundary distance image. Alternatively, the basic shape of the objects may be inputted by the user prior to execution of the method of the present invention. In another embodiment, a list of basic shapes may be inputted by the user prior to execution of the method and the method then uses the entries arranged in the list and by referring to the boundary distance image to assign a basic shape to each object in the image.

The (geometric) parameters for the basic shapes can be obtained by referring to the boundary distance image at the location of a pixel within the at least one inner mask.

In a preferred embodiment, the said at least one pixel is selected as the at least one centroid pixel and the location of said at least one pixel is thus the location of said at least one centroid pixel. As a set of non-limiting examples, if the basic shape of the object associated with the inner mask is a circle, the value of the centroid pixel in any of the boundary distance image will give the radius of the circle. If for instance, the basic shape of the object associated with the inner mask is a square, the value of the centroid pixel in a single boundary distance image corresponding to a given direction (e.g., assuming a set of four unique directions, any one of the directions (1,0), (−1,0), (0,1) or (0,−1)) will be equal to half of the length or width of the square. If for instance, the basic shape associated with the inner mask and centroid is a rectangle, the value of the centroid pixel in a single boundary distance image corresponding to a given direction (may also be referred to as an image channel) may be equal to half of the length of the rectangle, while the value of the centroid pixel in another boundary distance image corresponding to a different direction may be equal to half of the width of the rectangle. If a basic shape is a triangle, at least three directions are needed to determine the distance to each side of the triangle. If a shape is a polygon, vertices can be made with coordinates at the distance from centroid specified by different directions. Typically, the number of boundary distance images and the respective directions are preferably selected according to the type of basic shapes, or to a list of types of basic shapes, associated with the objects in the image. However, any suitable number of unique image channels (or directions) may be selected as will be recognized by the person skilled in the art.

In one embodiment, the method may further comprise the step of adjusting pixels located on the edges of the basic shape by referring to the corresponding pixels in the boundary distance images after determining said at least one parameter of the basic shape. In other words, for a given edge/boundary pixel of a basic shape associated with an object, the value of the pixel in the boundary distance image in the direction of the boundary of the object will yield the distance of said pixel from the true boundary, allowing the edges/boundary of the basic shape to be adjusted to that of the boundaries of the object.

In one embodiment, the step of predicting at least one inner mask for at least one object comprises the steps of; training a machine learning model on a set of training images, wherein the set of training images comprises a set of digital images and corresponding target inner masks (i.e., inner masks being the target property during training of the machine learning model) and using said trained machine learning model to predict at least one inner mask for at least one object in said image.. The training set comprises a set of digital images as the input images and the corresponding at least one inner mask for each object comprised in a digital image as the output/target property. After training, the trained machine learning model can be used to predict at least one inner mask for each object comprised within the given input image, for example for an input image not included in the training set. The training set may comprise any number of training images and the corresponding inner mask(s) and to improve the accuracy of the prediction more training data may be added to the training set.

In one embodiment, the step of determining an instance segmentation from said at least one inner mask may comprise steps of; training a machine learning model on a set of training images, wherein set of training images comprises a set of inner masks and the corresponding target instance segmentation, using said trained machine learning module to predict instance segmentation using the at least one inner mask as input, calculating overlap between two instances of said precited instance segmentation and/or inner masks, if overlap between two instances and/or inner masks is above an overlap threshold, the two instance segmentations are combined into a single inner mask and/or instance segmentation.

The training set comprises a set of images comprising inner masks as the input images and the corresponding instance segmentation as the output/target property. After training, the trained machine learning model can be used to predict instance segmentation of an image for a given set of inner masks, for example for an input image comprising at least one inner mask that is not included in the training set. The training set may comprise any number of training images and the corresponding instance segmentations and to improve the accuracy of the prediction more training data may be added to the training set.

In one embodiment, the overlap metric (i.e., a metric determining the extent of overlap between two or more instances, two or more inner masks or between at least one inner mask and at least one instance) may be selected as Dice Similarity Coefficient, Jaccard index, F1-Score, Intersection Over Union, etc.

In one embodiment, the value of overlap threshold is optimized according to a training set. Alternatively, the value may be selected manually depending on the given overlap metric and the objects in question.

Various embodiments of the computer-implemented method of the present invention may require training and use of machine learning, where the machine learning models used for the different embodiments of the invention are preferably selected as deep learning neural networks such as, but not limited to, convolutional neural networks or as a transformer.

In some embodiments, the predicted inner masks and/or instance segmentation may be used to separate and/or identify objects (i.e., objects of interest) from the background in an image. Moreover, said method may be used to count said objects arranged within the image and/or to measure shape of said objects, determine whether an object is damaged or deformed, as well as, to track objects over time. In other words, in some embodiments, the method may further comprise the step of counting objects. In some embodiments, the method may further comprise the step of measuring the shape of said objects or instances. In some embodiments, the method may further comprise the step of measuring the size of said objects or instances. In some embodiments, the method may further comprise the step of determining whether an identified object or instance is damaged or deformed, i.e., the object or instance comprises an anomaly. In some embodiments, the method may further comprise the step of tracking an object or an instance over time. In some embodiments, the one or more of the above described steps may be used, or any combination thereof.

In some embodiments, the method may further comprise the step of returning and/or outputting one or more of the following: the count, the measured size, the measured shape, the measured anomalies and the trajectory of the tracked object.

In some embodiments, the step of counting may comprise counting the number of segmentation images (i.e., one segmentation image for each instance). Alternatively, the step of counting may comprise counting the number of shape parameters.

In some embodiments, the step of measuring the size of an object or instance may comprise calculating the number of pixels that correspond to that specific instance or object, i.e., the area of the instance or object. The step of measuring the size of an object or instance may further use the field of view of the image sensor (such as camera) and the resolution of the image to measure the size of said object or instance. As a non-limiting example, if a camera is positioned 60 cm away from a flat circle and the image from the camera with resolution 1000×1000 shows that the circle has a 10 pixel radius with a total field of view width of 40 cm which translates to an angle of about 33.7 degrees for half of the field, the angle subtended by the 10 pixels is a small fraction of this. Using trigonometric calculations, specifically the tangent function, it is possible to estimate the actual radius of the circle as tan(0.67×π/180)×400 mm. Hence, the real radius of the circle is determined to be approximately 4.68 mm. In some embodiments, the step of determining whether an identified object or instance is damaged or deformed may comprise cropping a selected instance or an object and input it into an anomaly detection or quality inspection algorithm to determine whether said instance or object is of acceptable quality. Such an algorithm may e.g., comprise comparing said selected instance to an ideal instance of said object and calculate a statistical measure of difference between the two. If the difference value exceeds a threshold value, the instance or object may be identified as damaged, or deformed.

In one embodiment, the step of tracking an object or an instance over time comprises: receiving a plurality of images, preferably a series of images sampled over an interval of time, carrying out an instance segmentation for each of the plurality of images, identifying an instance or an object to track, then identifying said identified instance or object in each image for said series of images. Alternatively, the step of tracking an object or an instance over time comprises receiving one or more images, carrying out an instance segmentation for the said one or more images, identifying an instance or an object to track, and predicting the location of the object at a future timepoint assuming a known velocity (e.g., by measuring the displacement of a conveyor belt using an encoder).

In some embodiments, the objects may be food stuff or metal ingots such as, but not limited to, aluminium ingots. The images of food stuff may be, but are not limited to, images of eggs, fish eggs, fish, fish roes, aquaculture feed, shrimp, seafood, shellfish, or other crustaceans.

In an aspect of the invention, a system for carrying out instance segmentation of an image comprising an image of objects and background as described and defined above in relation to embodiments of the computer-implemented method of

### The Present Invention,

In an aspect of the invention, a system for carrying out instance segmentation of an image comprising at least one object and background for identifying at least one object in said image, is provided.

In the preferred embodiments, said system may comprise at least one output means, at least one computer-readable memory and at least one processing unit.

In some embodiments, the at least one processing unit may be adapted to: receiving a digital image, or representation thereof, storing the image data in said computer-readable memory, executing a set of executable instructions on said image data, wherein the set of executable instructions comprise said computer-implemented image segmentation method according to the computer-implemented method defined in any one of claims 1 to 19, and, outputting the instance segmentation and analysis results in said at least one output means.

In some embodiments, outputting the instance segmentation and analysis image segmentation and analysis results may comprise one or more of the following, outputting a segmented image or instance segmentations thereof, counting instances/objects in the image, and returning the number of objects comprised in said image, determining and returning the shape of each object comprised in the image, computing and returning the size or area of each object. Additionally, or alternatively, the analysis may detect whether at least one object is damaged and/or deformed. Additionally, the analysis may include tracking of displacement of instances/objects over time.

The output means is preferably a medium for the system to relay or return the analysis details to the user such as, but not limited to, a computer screen or via a software application on a mobile phone.

In one embodiment, the system further comprises a bus configured to transmit data between the computer-readable memory and the processor.

In one embodiment, the system further comprises at least one image sensor and a connection means or linkage between said image sensor and at least one said processing unit such that said image sensor can capture images of objects/items and transfer the image data to said at least one processor unit. The image sensor may be selected as an industrial camera of a suitable choice as recognized by the person skilled in the art. The connection means may be wired or wireless means of connection.

In one embodiment, the image sensor is configured to capture at least one image and send said captured image to at least one processing unit.

In one embodiment, the at least one image sensor further comprises a protection against dust or water particles e.g., by using a protective layer on the at least one image sensor or by blowing pressurized gas to clean the lens. In one embodiment, the pressurized gas is air blown through a nozzle directed at or away from the at least one image sensor.

The position of the at least one image sensor may be adjustable, such as by mechanical or electrical moving means. In one embodiment, the at least one image sensor may be mounted on at least one sled movable within a frame comprising a slit mated to the sled. Alternatively, the objects/items to be imaged may be arranged or fed to a moving means such as, but not limited to, a conveyor belt.

In one embodiment, the system may further comprise a means for removing deformed, or damaged, at least one object from said moving means uses the detection whether at least one object is damaged or deformed. In some embodiments, the means for removing deformed, or damaged, at least one object may be a robotic arm. In some embodiments, it may remove a deformed or a damaged object from a moving means. In some embodiments, it may remove a deformed or a damaged object from a static holding means.

In one embodiment, the image sensors may be used to capture a series of images over a period of time to obtain a time resolved image analysis.

### BRIEF DESCRIPTION OF FIGURES

FIG. 1 illustrates a flowchart for an embodiment of the computer-implemented method for performing an instance-segmentation of a digital image.

FIG. 2 shows a flowchart illustrating an embodiment of a typical training phase of a machine learning model for a given target property.

FIG. 3 illustrates a flowchart of an embodiment of the present invention, wherein boundary distance images are used to obtain inner mask(s) for each object and the inner mask(s) used to determine the basic shape associated with each object to obtain an instance segmentation.

FIG. 4 illustrates how an inner mask is determined for a prototypical object.

FIG. 5 illustrates a flowchart of an embodiment of the present invention, wherein a machine learning model is used to predict inner mask(s) for each object and a second machine learning model used to predict instance segmentation from said predicted inner mask(s).

FIG. 6 illustrates an embodiment of the present invention, wherein a system comprising a control unit and an image sensor is used to image fish arranged on a moving means and the computer-implemented method is used to process and analyze said image, e.g., counting said fish and/or identifying damaged fish.

FIG. 7 illustrates an embodiment of the present invention, wherein a system comprising a control unit and an image sensor arranged on a moving means is used to image fish arranged on a static surface.

### DETAILED DESCRIPTION

In the following, and in the foregoing, exemplary embodiments of the invention will be described. These examples are provided to provide further understanding of the invention, without limiting its scope.

In the following description, a series of steps are described. The skilled person will appreciate that unless required by the context, the order of steps is not critical for the resulting configuration and its effect. Further, it will be apparent to the skilled person that irrespective of the order of steps, the presence or absence of time delay between steps, can be present between some or all the described steps.

As used herein, including in the claims, singular forms of terms are to be construed as also including the plural form and vice versa, unless the context indicates otherwise. Thus, it should be noted that as used herein, the singular forms “a,” “an,” and “the” include plural references unless the context clearly dictates otherwise.

Throughout the description and claims, the terms “comprise”, “including”, “having”, and “contain” and their variations should be understood as meaning “including but not limited to” and are not intended to exclude other components.

The present invention also covers the exact terms, features, values, and ranges etc. in case these terms, features, values, and ranges etc. are used in conjunction with terms such as about, around, generally, substantially, essentially, at least etc. (i.e., “about 3” shall also cover exactly 3 or “substantially constant” shall also cover exactly constant).

The term “at least one” should be understood as meaning “one or more”, and therefore includes both embodiments that include one or multiple components. Furthermore, dependent claims that refer to independent claims that describe features with “at least one” have the same meaning, both when the feature is referred to as “the” and “the at least one”.

It will be appreciated that variations to the foregoing embodiments of the invention can be made while still falling within the scope of the features disclosed in the specification, unless stated otherwise, can be replaced by alternative features serving the same, equivalent, or similar purpose. Thus, unless stated otherwise, each feature disclosed represents one example of a generic series of equivalent or similar features.

Use of exemplary language, such as “for instance”, “such as”, “for example” and the like, is merely intended to better illustrate the invention and does not indicate a limitation on the scope of the invention unless so claimed. Any steps described in the specification may be performed in any order or simultaneously unless the context clearly indicates otherwise.

All of the features and/or steps disclosed in the specification can be combined in any combination, except for combinations where at least some of the features and/or steps are mutually exclusive. In particular, preferred features of the invention are applicable to all aspects of the invention and may be used in any combination.

Various modules and algorithm operations described in the embodiments here may be executed as electronic hardware, computer software, or a combination of both. Therefore, the disclosure may employ functional language either entirely or partially. The choice between hardware or software implementations depends on the specific application. The person skilled in the art may adapt the described functionality in different ways depending on the application, yet these choices should not be seen as deviating from the scope of the claims.

The disclosure has been detailed with reference to specific examples, but it is understood that those knowledgeable in the field might make modifications or substitutions to these examples without straying from the intent and boundaries of the disclosure, i.e., the scope, as outlined in the claims. For instance, elements or features from various examples may be mixed or replaced with one another within the confines of this disclosure and the associated claims.

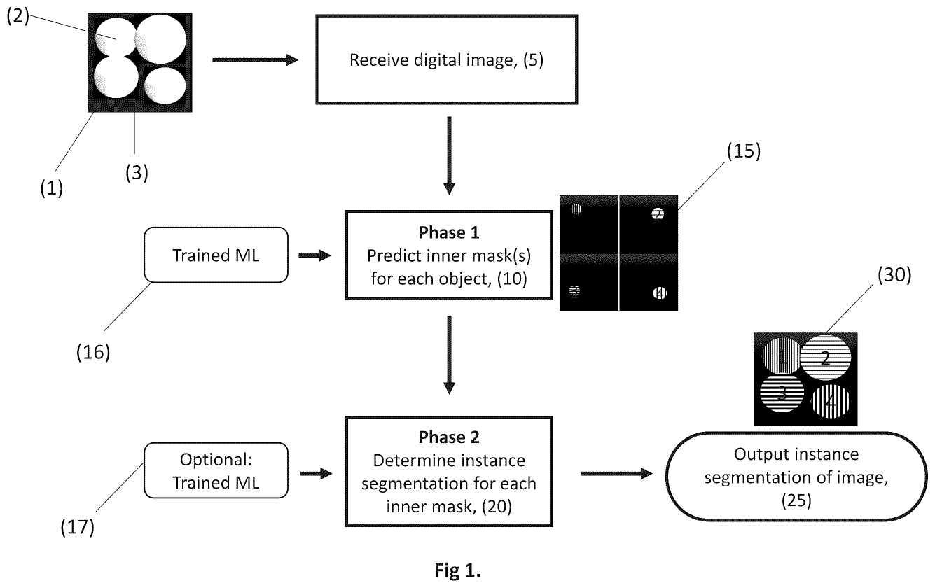

FIG. 1 illustrates a flow chart outlining the steps of the computer-implemented method used to carry out an instance segmentation of an input image (1) comprising 4 round objects

Initially, the input image is received and processed by a processing unit (i.e., a processing unit of a camera) to generate a digital image (5), or a representative thereof, for the input image. As would be recognized by the one of ordinary skill in the art, the image may then be provided by a camera to a control unit for further processing. In some embodiments, this control unit may be a either a local or remote computer comprising at least one processor unit. The digital image, or representation thereof, may be stored in a (non-transitory) computer readable memory. A digital image comprises a collection of pixels defined by the dimensions of the input image (1). The digital image may comprise objects (2) (i.e., the objects of interest to be analyzed in the digital image) and a background (3), wherein the background (3) comprises all pixels of the digital image that do not belong to the objects. In other words, an object (2) is separated from the background and other objects of interest by an encapsulating boundary around the pixels comprised in the object, forming a closed shape and pixels belonging to the boundary are referred to as boundary pixels. A prototypical image is shown as inset (1), wherein the objects of interest are four spherical shapes which may for example be representative of eggs or metal ingots.

In the first phase of the method (10), at least one inner mask is predicted for each object (2) of the digital image. The inner mask of an object refers to at least one pixel or more generally a collection of pixels that belong to an object associated with the inner mask such that the inner mask pixels are positioned within the encapsulating boundary of the object. The value of the pixels belonging to the inner mask are assigned a non-zero value, while the remainder of the pixels are assigned a zero value. The decomposition (or segmentation) of the input image (1) to a set of four inner masks is illustrated by an inset figure (15). In input images wherein two or more objects may have coinciding boundaries (i.e., the two objects exhibit overlap in the image), a single object may yield two or more inner masks.

The prediction of inner masks (10) for each object requires a trained machine learning model (16) such as, but not limited to, convolutional neural networks, wherein the machine learning model has been trained to predict a target property such as, but not limited to, a set of boundary distance images for the input image or a direct prediction of at least one inner mask for the input image.

The machine learning model may preferably be trained prior to receiving said input image (1) using a training set of images, wherein the training set comprises a set of digital images and the corresponding desired target property representative for the digital images.

In the second phase of the method (20), the inner masks are used to obtain an instance segmentation for the input image.

In one embodiment, the different inner masks representative of the objects needs to be separated into different instances of inner masks. This may be achieved by using connected component labelling method.

The basic geometrical parameters defining the object shape associated with an inner mask are obtained from boundary distance images, such as, but not limited to, radius and center for a circle or width and length of a rectangle. Given the geometrical parameters, instance segmentation may be constructed from the inner masks, and the basic shapes may be refined by adjusting the boundary pixels of the basic shape.

Alternatively, a second trained machine learning model (17) may be trained to predict instance segmentation from a set of inner masks and used directly on the result from the first phase of the method, or in various embodiments after the step of inner mask separation, to predict instance segmentation for the input image.

The instance segmentation of the original input image may then be outputted (25) and in some embodiments further analyzed. In some embodiments, the size and shape of the different instances may be analyzed. The final instance segmentation for the input image (2) comprising four spherical shapes is shown as an inset (30), wherein each object, or instance, has been separated and is given a unique numeric value for clarity.

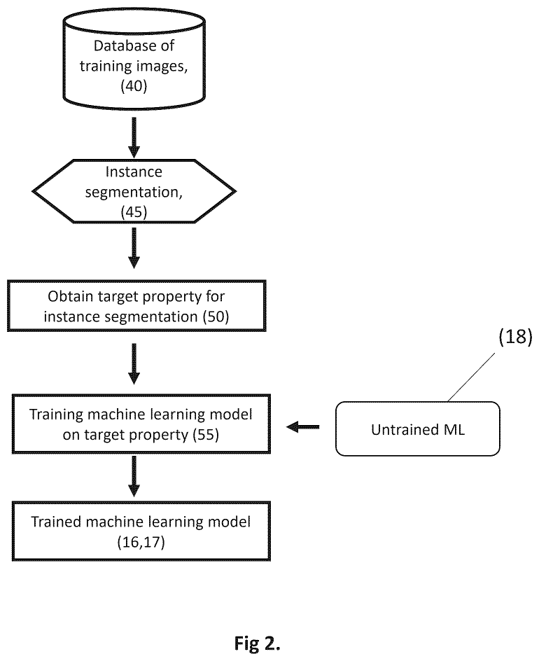

FIG. 2 shows a flowchart for the training phase of a machine learning model, wherein the function between a known set of input digital images, or a database thereof (40), and the corresponding ground-truth output is learned, e.g., by approximating ground truth labels with human made labels, i.e., a labelled ground-truth instance segmentation is constructed for a known dataset of training digital images.

The input digital images may be instance segmented (45) and the ground-truth instance segmentation may be obtained for any desired target property or output such as, but not limited to, boundary distance images or at least one inner mask for each instance (or object) of the image (50).

An untrained machine learning model (18) may be trained, as would be recognized by a person skilled in the art, using the input digital images and the desired corresponding output property (55) to obtain a trained machine learning model (16,17).

The untrained machine learning model (18) may be selected as, but not limited to, a deep neural network model, such as a convolutional neural network or a transformer. The trained machine learning model (16,17) may then be used to predict the desired target property for a new image (i.e., an “unknown” image) that was otherwise not included in the training set.

As a non-limiting example, given a dataset of training images and a corresponding ground truth instance segmentation a set of carefully prepared inner masks may be constructed (e.g., by human labelling) and used to train a machine learning model such that the machine learning model (17) can be used to predict at least one inner mask for each object of an image not included in the dataset (40). Alternatively, the machine learning model may be trained to predict instance segmentation from at least one inner mask.

In one embodiment, a plurality of machine learning models of various types may be trained for prediction of different target properties.

In one embodiment, the different machine learning models may be trained on different datasets of training images and the corresponding ground-truth instance segmentations.

In the preferred embodiment, the training of the machine learning models is carried out prior to capturing, or receiving, a digital image. In some embodiments, there may be significant time-lag present between the training of the at least one machine learning prior to using the at least one trained machine learning for prediction of one or more target properties.

In various embodiments, unsupervised learning may be used instead of supervised learning.

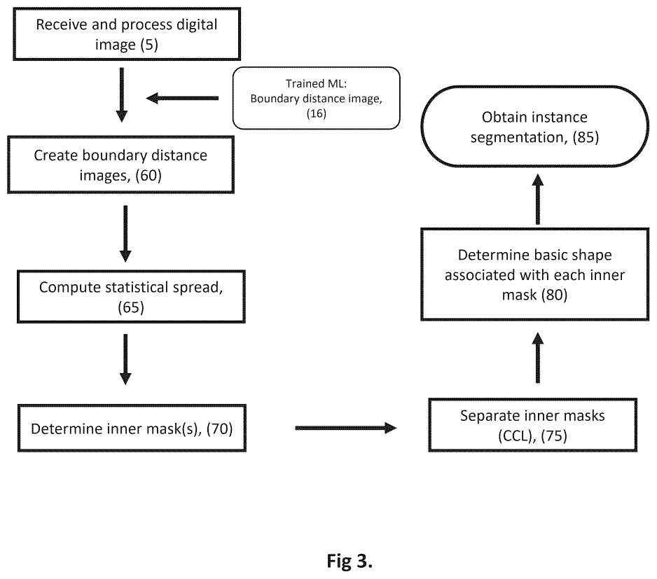

FIG. 3 shows a flowchart for an embodiment of the present invention, wherein after receiving an image and processing it into a digital image (5), a trained machine learning model (16) may be used to predict a set of boundary distance images (or a set of boundary distance masks) (55) for the digital image, wherein the value of a pixel in a given position is indicative of the distance of said pixel from the closest boundary pixel in a given direction. Thus, a set of boundary distance images may be generated by applying a distance transform to the value of each pixel for a set of (unique) directions. In one embodiment, four different directions can be represented by the four Cartesian unit vectors (−1,0), (1,0), (0,1), (0,−1) to obtain a set of four boundary distance images, one for each direction. The boundary distance images are made by applying a distance transform to the value of each pixel on each instance or object (thus disregarding background) along the given direction.

Given the set of boundary distance images, a measure of statistical spread may be computed (65), over the set of boundary distance images, for each pixel with a given spatial position, wherein the statistical spread may be selected as, but not limited to, variance or standard deviation.

Regions of pixels comprising low statistical spread (if variance or standard deviation is used) can then be used to identify/determine inner masks associated with objects comprised in the digital image (70). In one embodiment, at least one inner mask for each object is generated by thresholding the statistical spread according to a (pre-determined or iteratively determined) threshold value.

In one embodiment, the threshold value might be determined from an optimization of the threshold value with reference to an at least one accurate example of decomposition of a digital image to inner masks. In one embodiment, the inner masks may be selected as pixel(s) with extremal values in the spread (i.e., showing a local minimum or maximum in the statistical spread), also known as a centroid, which substantially may translate to the pixel(s) positioned at the center of the inner mask.

Separate instances of inner masks may then be identified by connected component labelling (CCL) (75).

Once the inner mask has been determined, the geometrical parameters and the basic shape associated with the object represented by the inner mask can be determined (80) by referring to the boundary distance images at the coordinates corresponding to the at least one inner mask, or in some embodiments to the centroid pixel(s).

For example, for a circular object the value of the centroid pixel will yield the radius of the circle in the boundary distance image. Similarly, distance to the boundaries along different directions will allow geometrical parameters for shapes such as, but not limited to, elliptical and polygonal shapes to be determined. In one embodiment, the basic shape type of the objects comprised in the digital image may be inputted a priori by the user, if the shape of all objects is circular. Then, instance segmentation can be obtained, and in some embodiments outputted, by converting the pixels belonging to shapes and its inner masks (and centroids) to an instance segmentation image (e.g., various polygon to raster functions) (85). The inner masks, and/or coordinates and/or shape parameters may be sufficient for a specific use case, such as counting, and the shapes need not be converted to segmentation images or an instance segmentation image.

In one embodiment, an additional step may be included (not shown), wherein the contours or boundary of the basic shape predicted in the initial instance segmentation are refined. Then, the boundary pixels of the initial predicted instance segmentation may be adjusted to match the boundary pixels given by the boundary distance image. For example, for a given pixel in the initial predicted instance segmentation, a boundary distance image generated according to a given direction will show the distance to the closest boundary along the given direction, allowing the boundary pixels of the predicted instance segmentation to be adjusted. In another embodiment, wherein the basic shape may be a polygon, the refinement of the boundaries may be done iteratively, such as by starting with the edge pixels that are halfway between two polygon vertices and extending the polygon to the new vertex defined by the distance to the boundary at the edge pixel.

In yet another embodiment, an additional step may be included (not shown), wherein the basic shape constructed from the inner masks may be considered to belong to the same object in the digital image (or instance) and may be connected through a common, shared, boundary. For example, if two basic shapes are found to have a significant overlap. Herein, significant overlap may be determined by a predetermined threshold for an overlap metric (e.g., if Dice Similarity Coefficient is larger than 0.5 or another appropriate threshold value, depending on the metric and problem at hand) or by a machine learning model (wherein a deep neural network model is trained to learn for this specific purpose).

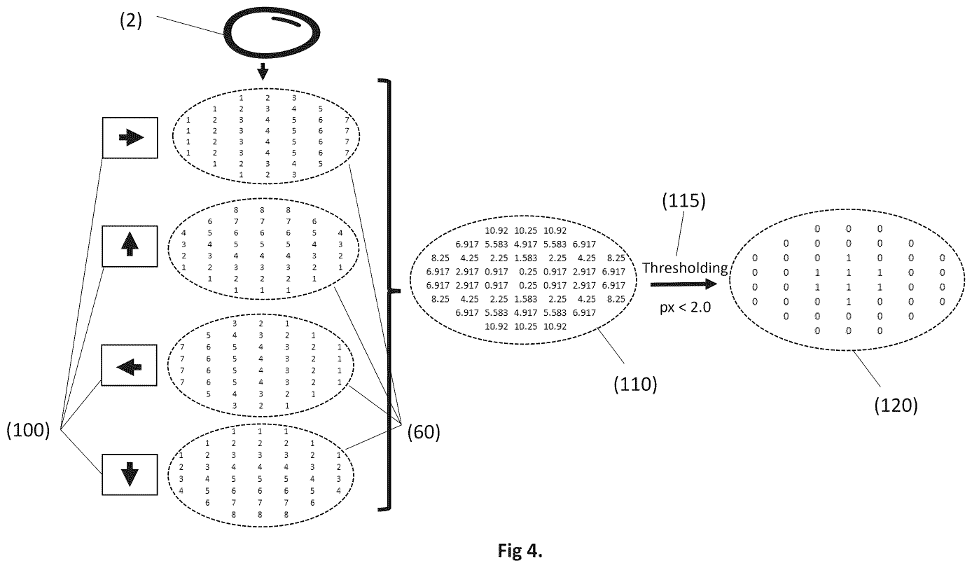

FIG. 4 illustrates a non-limiting example for a method for determining an inner mask (120) for a single object (2) of an elliptical shape that may be found in a digital image, wherein the object may be an image of an egg. Note that in typical applications, a digital image may comprise one or more objects to be identified. In some applications, one or more objects may be of elliptical shape or of any other shape. Even, in some applications, the digital image may comprise only a background. In such applications, the method would not return an inner mask.

In the first step, a set of directions may be defined (100), and a set of boundary distance images may be generated (60), wherein each boundary distance image corresponds to a particular direction. The set of boundary distance images may be generated by using a trained machine learning model (16). For a particular boundary distance image, the value of a given pixel gives the distance of said pixel from the nearest boundary of the object in the selected direction.

In the next step, the set of boundary distance images is collectively used to compute the variance (or any other measure of statistical spread) in distance for each pixel, obtaining a distance variance mask for the object (110).

As is evident from the given example in FIG. 4, the innermost region of the elliptical shape exhibits lower variance for each pixel. Thus, to determine an inner mask (120) for the object or instance, the variance values are thresholded (115), wherein the variance in distance of each pixel is conditionally compared to a pre-determined threshold value (in this example, selected as 2.0) and only pixels that have lower values than said threshold value are included in the definition of the inner mask associated with the object. In some embodiments, the thresholding (115) may comprise iteratively refining the threshold value as described above.

In one embodiment, the variance (or the measure of statistical spread) may be filtered and/or smoothed such as by, but not limited to, gaussian blurring.

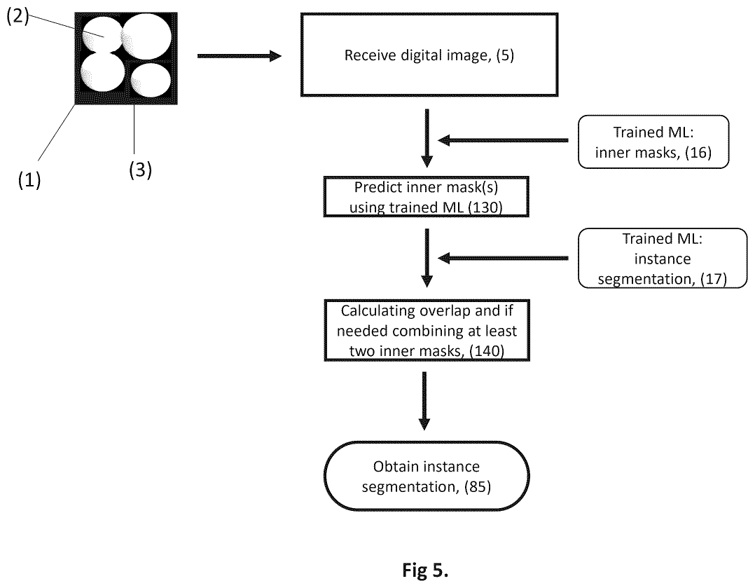

FIG. 5 shows a flowchart for an embodiment of the present invention for predicting instance segmentation. After receiving an image (1) and processing it into a digital image (5), a trained machine learning model (16) (i.e., said machine learning model is specifically trained to predict inner masks for an input digital image) is used to predict a set of inner masks for the input digital image (1), wherein at least one inner mask is associated with each object arranged in said digital image.

In the next step, a second trained machine learning model (17) (i.e., said second machine learning model is specifically trained a priori to predict instance segmentation from a set of inner masks) is used to predict an initial instance segmentation, from the previously predicted the inner masks. The initial instance segmentation may then be refined by calculating overlap between inner masks and/or between initial predicted instances and/or between inner masks and predicted instances and if two inner masks and/or instances exhibit significant overlap, they may be combined (140), to obtain an instance segmentation (85). This may for example be used to correctly treat cases such as where two objects in the digital image show substantial overlap, e.g., overlapping fishes on a conveyor belt or a band.

The instance segmentation may then be analyzed further, and/or output.

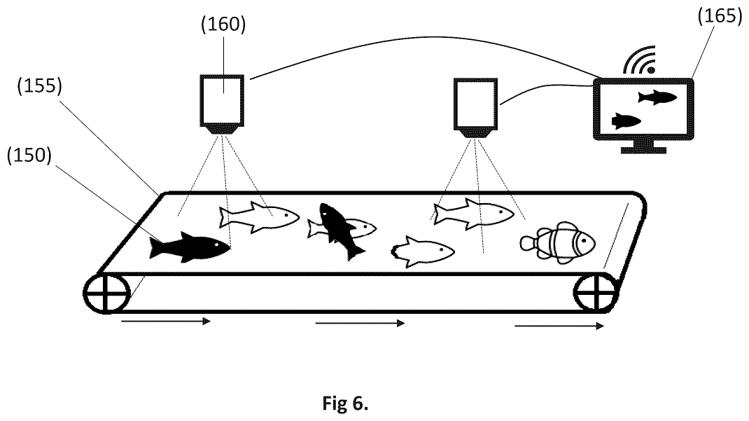

FIG. 6 shows an embodiment of the present invention used to analyze food items, in particular a plurality of fish (150), wherein the plurality of fish is fed to and arranged on a moving means such as a conveyor belt (155). The plurality of fish (150) may comprise various types of fish. Moreover, two or more fish may overlap and/or individual fish may be damaged, wherein individual parts of a fish may be missing such as, but not limited to, the caudal fin.

In one embodiment, the system may comprise two image sensors such as, but not limited to, an industrial digital camera. The image sensors (160) are used to image the plurality of fish (150) during the operation of the conveyor belt (155), the images are processed to digital images and sent from the image sensors (160) through a connection means to a control unit (165), preferably, comprising a processor unit for processing said image from the image sensor.

In one embodiment, the connection means a direct (wired) connection between the image sensor and the control unit. In alternative embodiments, the connection means may be wireless such as through Bluetooth or internet connection. The control unit receives the image and executes a set of executable instructions on the image, wherein the image is instance segmented as defined by the embodiments of the present invention. This allows the objects of interest (or the plurality of fish (150)) in the digital image to be separated from the background (or the conveyor belt (155)). Given the resulting instance segmentation of the digital image, the control unit may analyze the instance segmentation of the digital image for example to count the number of fishes arranged on the conveyor belt, categorize the fish types, sort individual fishes, resolve overlapping fishes, identify damaged fishes. Alternatively, the receiving control unit may be equipped with wireless connection to allow a second control unit (not shown) to access and wirelessly control the receiving control unit.

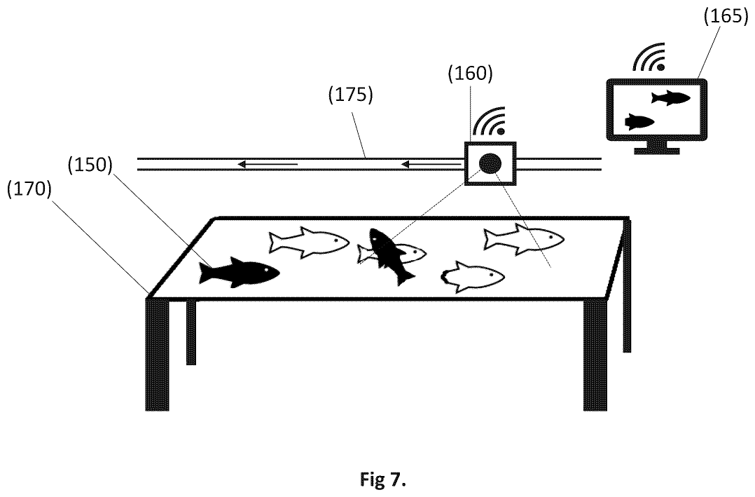

FIG. 7 shows an alternative embodiment of the present invention, wherein a plurality of fishes (150) is arranged on a static holding means such as, but not limited to, a rack or a tabletop (170). In this embodiment, the image sensor (160) is attached to an electric moving means (175) such as a sled movable within a slit arranged in a frame that in the lengthwise direction spans at least the length of the static holding means, allowing the plurality of the fishes (150) arranged on the static holding means to be imaged. The image sensor (160) further comprises a means of wireless connection, wherein the image sensor (160) can be connected wirelessly to a control unit (165) for processing and analysis of the plurality of fishes as is described by the present invention.

1. A computer-implemented method for instance segmentation of an image comprising at least one object and background for identifying at least one object in said image, wherein said computer-implemented method comprising steps of;
a. predicting at least one inner mask for at least one object in said image, wherein said at least one inner mask is a localized region of pixel that correspond to said at least one object with boundary pixels of said object excluded, and,
b. determining an instance segmentation from said at least one inner mask.

2. The computer-implemented method according to claim 1, wherein said step of predicting at least one inner mask for at least one object comprises steps of;
i. training a machine learning model on a set of training images, wherein said set of training images comprises a set of digital images and corresponding boundary distance images,
ii. generating a set of boundary distance images for said image using said trained machine learning module and said image as input,
iii. computing a measure of statistical spread across said set of boundary distance images for each pixel in said boundary distance images,
iv. defining the at least one inner mask for at least one object by thresholding said measure of statistical spread,
v. using connected component labelling to label each separate instance of inner mask.

3. The computer-implemented method according to claim 2, wherein the measure of statistical spread is selected as variance or standard deviation.

4. The computer-implemented method according to claim 2, further comprising the step of smoothing/blurring the measure of statistical spread across said set of boundary distance images.

5. The computer-implemented method according to claim 2, wherein determining an instance segmentation corresponding to said at least one individual inner mask further comprises steps of:
i. determining the basic shape associated with the at least one inner mask using the boundary distance image,
ii. determining the least one parameter of the basic shape from the boundary distance image at a location of at least one pixel within the at least one inner mask using data from the boundary distance image.

6. The computer-implemented method according to claim 5, wherein the pixel within the at least one inner mask is selected as at least one extremal pixel arranged within said at least one inner mask with respect to the value of the statistical spread.

7. The computer-implemented method according to claim 5, wherein the basic shape associated with each inner mask is determined by referring to the boundary distance image and/or inputted by the user.

8. The computer-implemented method according to claim 5, wherein the method further comprises a step of adjusting pixels located the edges of the basic shape by referring to the corresponding pixels in the boundary distance images after determining said at least one parameter of the basic shape.

9. The computer-implemented method according to claim 1, wherein predicting at least one inner mask for at least one object comprises the steps of:
i. training a machine learning model on a set of training images, wherein the set of training images comprises a set of digital images and corresponding target inner masks, and,
ii. using said trained machine learning model to predict at least one inner mask for at least one object in said image.

10. The computer-implemented method according to claim 9, wherein the step of determining the instance segmentation from at least one inner mask further comprises steps of:
1) training a machine learning model on a set of training images, wherein set of training images comprises a set of inner masks and the corresponding target instance segmentation,
2) using said trained machine learning module to predict instance segmentation using the at least one inner mask as input,
3) calculating overlap between two instances of said precited instance segmentation and/or inner masks,
4) if overlap between two instances and/or inner masks is above a pre-determined overlap threshold, the two instance segmentations are combined into a single inner mask and/or instance segmentation.

11. The computer-implemented method according to claim 10, wherein the value of the pre-determined overlap threshold is optimized according to a training set.

12. The computer-implemented method according to claim 1, wherein the trained machine learning model is selected as deep learning neural networks, or more preferably as convolutional neural networks.

13. The computer-implemented method according to claim 1, wherein the computer-implemented method further comprises one or more of the following: a step for counting said one or more objects arranged within said image, a step for measuring the shape and/or size of said one or more objects, a step for detecting whether one or more objects are deformed or damaged, and a step to track said one or more objects over time.

14. The computer-implemented method according to claim 13, wherein said step of counting said objects arranged within said image comprises counting the number of instances from an image.

15. The computer-implemented method according to claim 13, wherein said step of measuring shape and/or size of objects comprises steps of calculating the area of an instance and then using the area, the field of view and resolution of an image to calculate the size of said object.

16. The computer-implemented method according to claim 13, wherein said step for detecting whether one or more objects are deformed or damaged comprises steps of cropping one or more instances of one or more objects and determining automatically if its features fall in the category of acceptable or defective instance (e.g., using pre-determined criteria, image analysis and/or machine learning).

17. The computer-implemented method according to claim 1, wherein the objects comprised in said image are images of food stuff or metal ingots.

18. The computer-implemented method according to claim 17, wherein the said food stuff is selected from a group comprising eggs, seafood, fish, fish eggs, aquaculture feed, shellfish, shrimp, and fish roes.

19. The computer-implemented method according to claim 17, wherein the said metal ingots are aluminium ingots or aluminium alloy ingots.

20. A system for carrying out instance segmentation of an image comprising at least one object and background for identifying at least one object in said image, said system comprising:
a. at least one output means,
b. at least one computer-readable memory,
c. at least one processing unit, wherein the processing unit is adapted to:
i. receiving a digital image, or representation thereof,
ii. storing the image data in said computer-readable memory,
iii. executing a set of executable instructions on said image data, wherein the set of executable instructions comprise said computer-implemented image segmentation method according to the computer-implemented method defined in claim 1, and,
iv. outputting the instance segmentation and analysis results in said at least one output means.

21. The system according to claim 20, wherein the system further comprises at least one image sensor and a connection means or linkage between said image sensor and at least one said processing unit and/or computer-readable memory.

22. The system according to claim 21, wherein the at least one image sensor is configured to capture at least one image and transfer said captured image to at least one processing unit.

23. The system according to claim 22, wherein the at least one image sensor further comprises a protection against dust or water particles.

24. The system according to claim 20, wherein the position of the at least one image sensor is adjustable by mechanical or electrical moving means or wherein the objects to be imaged are arranged on a moving means.

25. The system according to claim 24, wherein the system further comprises a means for removing deformed, or damaged, at least one object from said moving means based on the analysis result.
